(19) United States
(12) Patent Application Publication
(10) Pub. No.: US 2018/0184638 A1
(43) Pub. Date: Jul. 5, 2018

(54) SPRAYER BOOM ASSEMBLY FOR A MOBILE LANDSCAPE SPRAYER

(71) Applicant: Prime Seasons, Inc., Whitehall, MI (US)

(72) Inventor: Peter Gus Parling, Whitehall, MI (US)

(21) Appl. No.: 15/396,504

(22) Filed: Dec. 31, 2016

(51) Int. Cl. A01M 7/00; B05B 13/00

(52) U.S. Cl. CPC A01M 7/0057; B05B 13/005; A01M 7/0078; A01M 7/0075; A01M 7/0042

(57) ABSTRACT

A sprayer boom for a mobile landscape spraying apparatus having a wheeled chassis for movement of the spraying apparatus relative to a ground surface includes a sprayer boom assembly. The sprayer boom assembly includes an outer boom section that supports a spray nozzle for spraying a material onto the ground surface. A motor is configured to move the outer boom section relative to the chassis between an extended, sprayer mode position and a retracted, storage position. The outer boom section is capable of breakaway motion in the sprayer mode position in response to encountering an obstruction.

### TECHNICAL FIELD

The present disclosure relates to a sprayer boom assembly for a mobile landscape sprayer, and more particularly for a sprayer boom assembly having a section that is moveable between an extended position in which the sprayer boom is capable of breakaway movement and a retracted position.

### BACKGROUND

Landscape spraying devices are used in a variety of landscape settings to apply materials to lawns, gardens, and other landscaping surfaces, such as driveways, parking lots, and sidewalks. Landscape spraying devices can be used to apply nutrients and chemicals to soil and vegetation to promote or control growth, depending on the application. The spraying devices can also be used to apply treatments to hard landscape surfaces, such as driveways, parking lots, and sidewalks, to clean or protect these hard surfaces.

There are several types of spraying apparatus for applying materials to landscaping surfaces which generally fall into one of two categories—hand-held or wheeled. Hand-held devices are generally used to apply material to smaller areas and include a storage tank that is carried by the user. The storage tank stores a material that can be applied to the landscaping surface using a hand-held sprayer. For covering larger areas more quickly, the storage tank and sprayer can be designed to be mounted to a wheeled chassis that is driven over the ground surface. The wheeled chassis can be manually driven by the user or driven by connecting the chassis to a motorized apparatus, such as a riding lawn mower. In some apparatuses, a motor is mounted on the chassis to provide a self-propelled spraying apparatus.

As the wheeled landscape spraying apparatuses are driven over the ground surface, they often encounter different types of terrain, variations in elevation, as well as obstacles, such as debris, plants, and rocks, for example. Users often times try to operate the apparatus to avoid obstacles or sudden changes in elevation that could damage the spraying apparatus or other property. The faster the apparatus is driven over the ground surface, the more challenging it can be to avoid obstacles that may be encountered during use.

### SUMMARY OF THE DESCRIPTION

A sprayer boom assembly for a mobile landscape spraying apparatus includes a motor for selectively extending and retracting a portion of the boom assembly between a storage mode position and a sprayer mode position. While in the sprayer mode position, the extended portion of the boom assembly is configured for breakaway motion in response to encountering an obstruction during use of the spraying apparatus.

In one embodiment, a sprayer boom assembly is provided for a mobile landscape spraying apparatus including a chassis and at least one wheel mounted to the chassis for movement of the spraying apparatus relative to a ground surface. The sprayer boom assembly includes an inner boom section mounted to the chassis and an outer boom section. The outer boom section is pivotably coupled to the inner boom section and moveable between an extended position and a retracted position. A motor is operably coupled to the outer boom section and configured to move the outer boom section relative to the inner boom section between the extended and retracted positions. A breakaway assembly is coupled to the outer boom section and defines an arc of travel having a resting position and a breakaway position. When the outer boom section is placed in the extended position by the motor and the outer boom section encounters an obstruction, the outer boom section moves along the arc of travel from the resting position to the breakaway position in response to the obstruction.

In another embodiment, the breakaway assembly includes a biasing element adapted to bias the outer boom section into the resting position. The outer boom section can move along the arc of travel toward the breakaway position in response to encountering an obstruction, and the biasing element can apply a biasing force to the outer boom section to drive the outer boom section back into the resting position.

In still another embodiment, the motor can be operably coupled to the outer boom section by a cam plate. The motor can be adapted to rotate the cam plate to move the outer boom section between the extended and retracted positions. The breakaway assembly can include a channel formed in the cam plate that defines the arc of travel. The outer boom section may be connected to the cam plate by a follower pin inserted through the channel. The follower pin can be moveable along the channel to allow the outer boom section to move between the resting and breakaway positions in response to encountering an obstruction. The sprayer boom assembly can further include a biasing element connected to the follower pin to bias the outer boom section into the resting position.

In another embodiment, the outer boom section may be coupled to the inner boom section by a pivot pin or a hinge. The outer boom section can be configured to move in a plane that is parallel to or orthogonal to a longitudinal axis of the inner boom section during movement between the extended and retracted positions. The breakaway assembly can be configured to limit the arc of travel to less than a full range of motion between the extended and retracted positions.

According to another embodiment, a mobile landscape spraying apparatus includes a drive assembly, a dispensing assembly, and a sprayer boom assembly. The drive assembly can include a chassis having a front, a rear, and first and second opposing sides extending between the front and rear. At least one wheel is mounted to the chassis and adapted to move the spraying apparatus relative to a ground surface. The dispensing assembly can include a tank mounted to the chassis for holding a material to be sprayed and a spray nozzle fluidly connected with the tank by a conduit for spraying material stored in the tank onto a landscaping surface. A pump can be configured to selectively supply the material from the tank to the spray nozzle through the conduit. The sprayer boom assembly includes a sprayer boom having an inner boom section mounted to the chassis and an outer boom section pivotably coupled to the inner boom section. The sprayer boom can be configured to support the spray nozzle. A motor can be mounted to the inner boom section and operably coupled with the outer boom section. The motor can be adapted to move the outer boom section relative to the inner boom section between (a) a sprayer mode in which the outer boom section is in an extended position for spraying the material stored in the tank onto the landscaping surface, and (b) a stored mode in which the outer boom section is in a retracted position. The sprayer boom assembly further includes a breakaway assembly coupling the outer boom section to the inner boom section. The breakaway assembly can define an arc of travel of the outer boom section relative to the inner boom section which is defined by a resting position and a breakaway position. When the outer boom section is in sprayer mode, the outer boom section is moveable between the resting position and the breakaway position in response to encountering an obstruction.

In another embodiment, a first sprayer assembly is disposed on the first side of the chassis and a second sprayer assembly is disposed on the second side of the chassis. The first sprayer assembly can be configured to spray material onto the landscaping surface adjacent the first side in sprayer mode and the second sprayer assembly can be configured to spray material on the landscaping surface adjacent the second side in sprayer mode.

In still another embodiment, the spraying apparatus can include a user selectable actuator operably coupled to the motor to selectively control the motor to move the outer boom section between the sprayer mode and the stored mode.

According to another embodiment, a method of use for a sprayer boom assembly of a mobile landscape spraying apparatus is disclosed. The mobile spraying apparatus includes a chassis and at least one wheel mounted to the chassis for movement of the spraying apparatus relative to a ground surface. The method includes providing an inner boom section mounted to the chassis and providing an outer boom section pivotably coupled to the inner boom section. The outer boom section is moveable between an extended position and a retracted position. The method also includes driving the outer boom section relative to the inner boom section from the retracted position to the extended position. In response to the outer boom section encountering an obstruction, outer boom section can be pivoted from the extended position to a breakaway position to facilitate clearing the obstruction.

In another embodiment, the method includes biasing the outer boom section to return to the extended position after the obstruction is cleared. Driving the outer boom section can include actuating a motor to drive the outer boom section from the retracted position to the extended position.

These and other advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a schematic of a mobile landscape spraying apparatus according to an embodiment of the present disclosure.

FIG. 2 shows a control diagram for a sprayer boom assembly for use with a mobile landscape spraying apparatus according to an embodiment of the present disclosure.

FIG. 3 is a top-down view of a sprayer boom assembly in a retracted position according to an embodiment of the present disclosure.

FIG. 4 is an exploded view of the sprayer boom assembly of FIG. 3.

FIG. 5 is a top-down view of a sprayer boom assembly in an extended position according to an embodiment of the present disclosure.

FIG. 6 top-down view of the sprayer boom assembly of FIG. 5 in a first breakaway position according to an embodiment of the present disclosure.

FIG. 7 top-down view of the sprayer boom assembly of FIG. 5 in a second breakaway position according to an embodiment of the present disclosure

### DESCRIPTION

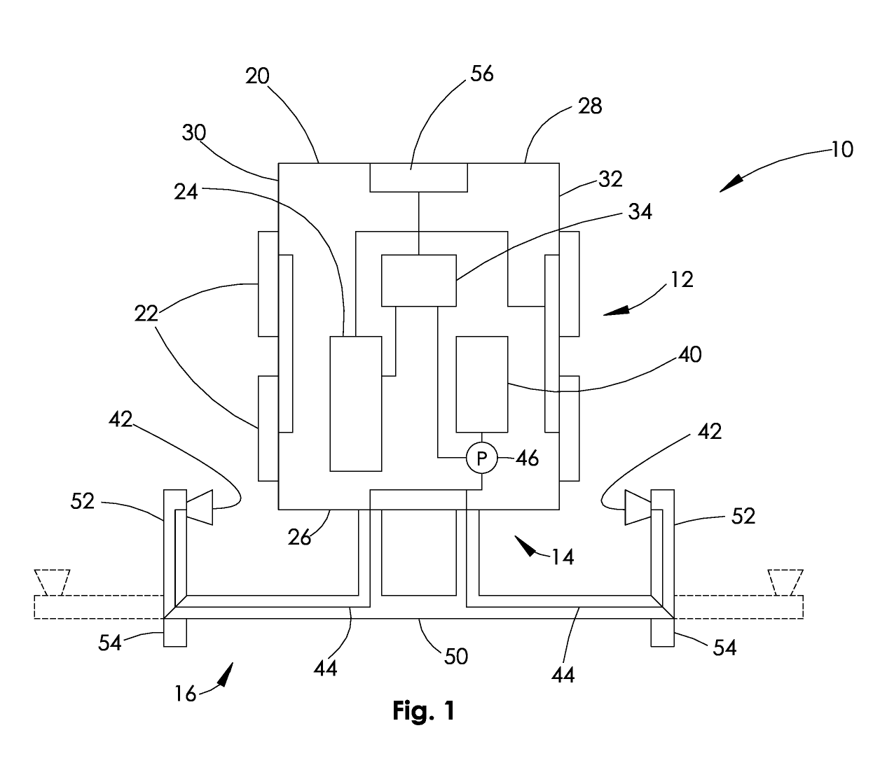

A mobile landscape spraying apparatus is illustrated in FIG. 1 and generally designated 10. The mobile landscape spraying apparatus 10 may be used to apply a material to a lawn, garden, or other landscaping surface, such as a driveway, a parking lot, or a sidewalk. Non-limiting examples of materials that can be applied by the spraying apparatus 10 include nutrients or chemicals to promote or control vegetation growth and treatments to clean or protect hard landscaping surfaces. As described in more detail below, the mobile landscape spraying apparatus 10 in one embodiment includes a sprayer boom assembly that is configured to selectively move a sprayer nozzle between a sprayer mode position and a storage mode position. When in the sprayer mode position, the sprayer boom assembly may be further configured with a breakaway assembly to reduce the likelihood of damage to the sprayer boom assembly when an obstruction is encountered.

Structure

The spraying apparatus 10 includes a power and drive assembly 12 for moving the apparatus 10 relative to a ground surface, a dispensing assembly 14 configured to selectively spray a material onto the landscaping surface, and a sprayer boom assembly 16. The power and drive assembly 12 can include a chassis 20 to which the other components of the spraying apparatus 10 are mounted, one or more wheels 22, and a motor 24. The motor 24 may be a gas or electric motor and is operably coupled to the wheels 22 through a suitable drive train (not shown) to selectively drive the wheels 22 to move the spraying apparatus 10 over the ground surface. The chassis 20 can include front and rear ends 26 and 28 and opposing first and second sides 30 and 32. As used herein, the “front” refers to the end of the chassis 20 which leads during travel of the spraying apparatus 10 over the ground surface during forward motion. The power and drive assembly 12 may also include a battery 34 for providing electrical power to one or more components of the spraying apparatus 10.

Still referring to FIG. 1, the dispensing assembly 14 can include a storage tank 40 for storing a material to be applied to the landscaping surface and at least one spray nozzle 42 for spraying the material onto the landscaping surface. The spray nozzles 42 may be configured to dispense the material as one of a mist, a spray, a stream, a shower, an aerosol, or combinations thereof. The spray nozzles 42 may also be configured to dispense liquid, solid, or gas material, or combinations thereof. The storage tank 40 may be operably coupled to the spray nozzles 42 through one or more fluid conduits 44 to supply the material from the storage tank 40 to the spray nozzles 42 for applying to the landscaping surface. A fluid pump 46 may be coupled to the storage tank 40 for providing the material stored in the storage tank 40 to the spray nozzles 42 under pressure. The dispensing assembly 14 may include additional pumps and/or valves (not shown) to selectively control or direct the flow of material from the storage tank 40 to the spray nozzles 42, the details of which are not germane to the embodiments described herein.

The sprayer boom assembly 16 includes an inner boom section 50 mounted to the chassis 20 and at least one outer boom section 52. As illustrated in FIG. 1, the sprayer boom assembly 16 may include a pair of outer boom sections 52, one extending on each side 30, 32 of the chassis 20. Alternatively, the sprayer boom assembly 16 may include only a single outer boom section 52 extending on one side 30, 32 of the chassis 20 (not shown). Each outer boom section 52 may be pivotably coupled at a first, proximal end to the inner boom section 50 and include at least one spray nozzle 42 mounted along a length of the outer boom section 52 between the first, proximal end and a distal, second end. While only a single spray nozzle 42 is illustrated on each outer boom section 52, in alternative embodiments, multiple spray nozzles 42 may be disposed along the outer boom section 52 and optionally along portions of the inner boom section 50.

A motor 54 is connected to the inner boom section 50 to move the move the outer boom section 52 relative to the inner boom section 50. The motor 54 is configured to pivot the outer boom section 52 relative to the inner boom section 50 between (a) a storage mode in which the outer boom section 52 is in a position suitable for storage or transport of the spraying apparatus 10 when a material is not being applied to the landscape (solid lines in FIG. 1) and (b) a sprayer mode in which the outer boom section 52 is in a position suitable for applying a material to the landscape through the spray nozzle 42 (dashed lines in FIG. 1).

The configuration and mounting of the inner boom section 50 may vary as desired. As illustrated in FIG. 1, the inner boom section 50 may be mounted to the front end 26 of the chassis 20 and include a single arm extending between both outer boom sections 52. Alternatively, the inner boom section 50 may be mounted anywhere along the chassis 20 between the front and rear ends 26, 28. In another alternative embodiment, the inner boom section 50 may include separate first and second inner boom sections to which each of the outer boom sections 52 are pivotably coupled.

The spraying apparatus 10 may also include a user interface 56 configured to receive input from a user of the spraying apparatus 10. The user interface 56 may include one or more actuatable controls, such as levers, knobs, buttons, dials, etc. which the user can manipulate to control the various components of the spraying apparatus 10. The user interface 56 may be operably connected to the motor 24 to selectively power the spraying apparatus 10 on and off and the pump 46 to selectively control the flow of material from the storage tank 40 to the spray nozzles 42.

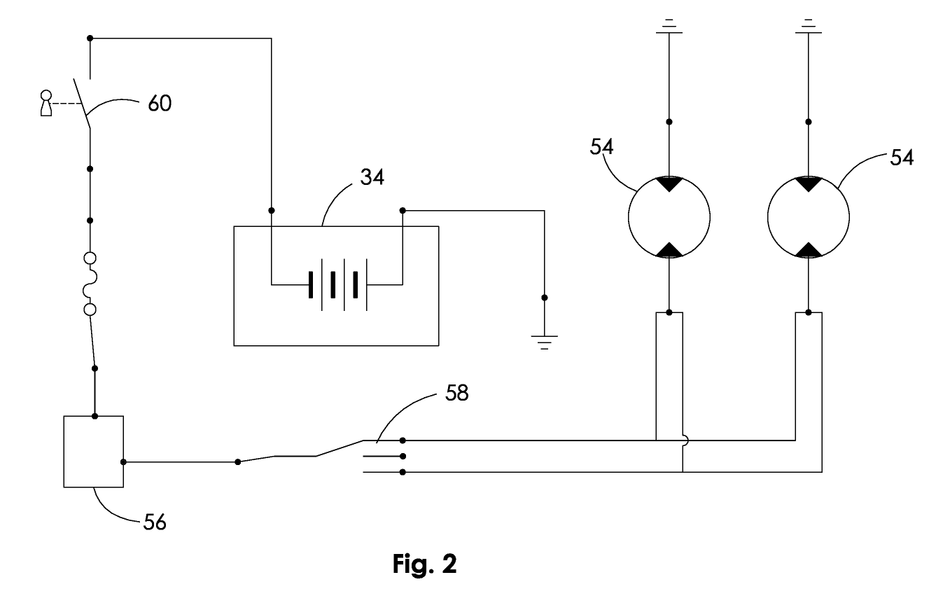

Referring now to FIG. 2, an exemplary control diagram for the motors 54 of the sprayer boom assembly 16 is illustrated. In this example, a reverse polarity switch 58 may be used to selectively control the motor 54 to pivot the outer boom section 52 between the retracted position (solid lines in FIG. 1) in storage mode and the extended position (dashed lines in FIG. 1) in sprayer mode. To move the outer boom section 52 into the extended position for use in the sprayer mode, a user may select the appropriate input in the user interface 56 to actuate the motor 54 to rotate in a first direction to move the outer boom section 52 from the retracted position to the extended position. To return the outer boom section 52 to the retracted position for storage or transport of the spraying apparatus 10, the user may select the appropriate input in the user interface 56 to actuate the reverse polarity switch 58 to reverse the polarity of the connection between the battery 34 and the motors 54. Reversing the polarity causes the motor 54 to rotate in a second direction, opposite to the first direction, to pivot the outer boom section 52 into the retracted, storage mode position. The reverse polarity switch 58 is optionally connected with the battery 34 through a key switch 60. The control circuit for the motors 54 may be integrated with the control circuit for the other components of the sprayer apparatus 10 or may be added to the sprayer apparatus 10 after production as an after-market add-on. The motors 54 may be configured to receive electrical power from the battery 34 or a separate battery for providing electrical power only to the motors 54 may be provided.

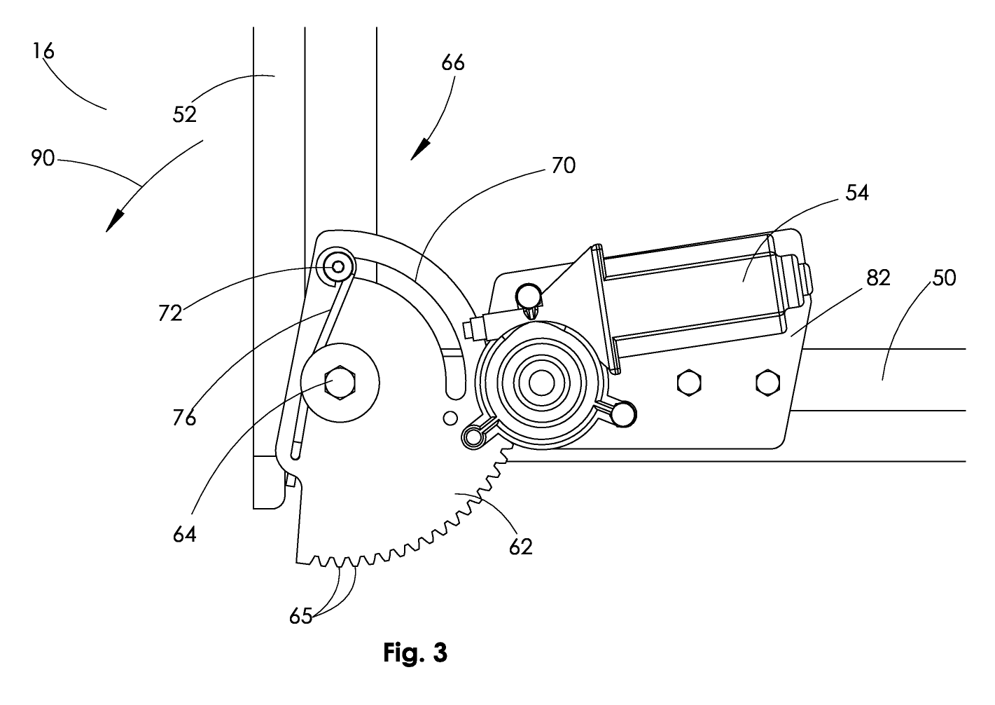

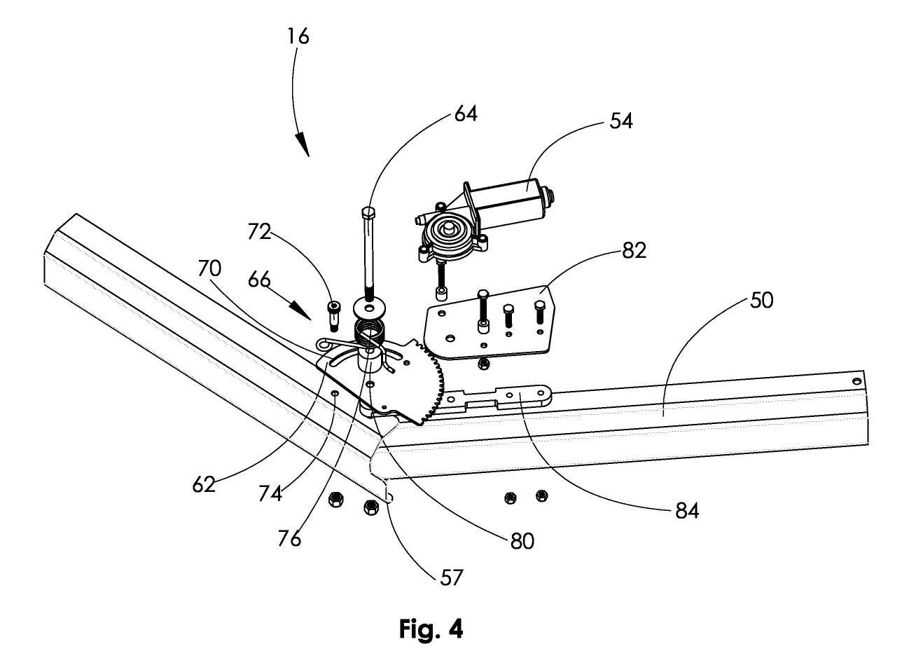

Referring to now to FIGS. 3 and 4, a single sprayer boom assembly 16 is illustrated. While the components of the sprayer boom assembly 16 extending on the first side 30 are illustrated and described, it will be understood that the sprayer boom assembly 16 extending on the second side 32 is configured in a similar manner, albeit as a mirror image of the sprayer boom assembly 16 on the first side 30. The outer boom section 52 is shown in FIG. 3 in the retracted position of the sprayer mode. The motor 54 is mounted on the inner boom section 50 and is configured to engage a cam plate 62 to pivot the outer boom section 52 relative to the inner boom section 50. The outer boom section 52 is pivotably connected to the inner boom section 50 by a pivot pin 64 that extends through the cam plate 62 and through aligned apertures (not shown) in the inner and outer boom sections 50, 52. The pivot pin 64 defines a pivot axis about which the outer boom section 52 rotates relative to the inner boom section 50. The pivot axis may extend perpendicular to a longitudinal axis of the inner boom section 50 such that the outer boom section 52 rotates within a horizontal plane defined by the longitudinal axis of the inner boom section 50. The cam plate 62 may include a plurality of teeth 65 configured to engage a motor gear (not shown) for movement of the cam plate 62 relative to the inner boom section 50. Alternatively, the outer boom section 52 may be pivotably connected to the inner boom section 50 through a hinge.

The sprayer boom assembly 16 may also include a breakaway assembly 66 coupling the outer boom section 52 to the cam plate 62. The breakaway assembly 66 is configured to allow the outer boom section 52 to deflect upon encountering an obstacle during use to avoid or minimize damage to the outer boom section 52 and connected spray nozzle 42. The breakaway assembly 66 includes a channel 70 defining an arc of travel through which the outer boom section 52 may move relative to the cam plate 62 and the inner boom section 50. The outer boom section 52 may be coupled to the breakaway assembly 66 by a follower pin 72 inserted through the channel 70 and through an aligned aperture 74 (FIG. 4). A biasing element 76 is coupled to the follower pin 72 to bias the follower pin 72, and thus the outer boom section 52, into a predetermined position relative to the cam plate 62. As illustrated in FIG. 4, the biasing element 76 may be in the form of a wound spring supported on a bushing 80 about the pivot pin 64.

Still referring to FIG. 4, the motor 54 may be mounted to the inner boom section 50 through a mounting plate 82. The motor 54, mounting plate 82, and inner boom section 50 may be coupled together using any suitable mechanical and/or non-mechanical fasteners, non-limiting examples of which include bolts (shown), pins, clamps, adhesives, welds, and combinations thereof. A guide plate 84 may extend from the inner boom section 50 to the outer boom section 52, between the inner boom section 50 and the mounting plate 82 and between the cam plate 62 and the outer boom section 52. The guide plate 84 may be configured to provide clearance for the first, proximal end of the outer boom section 52 to move relative to the inner boom section 52 during pivoting of the outer boom section 52 between the extended and retracted positions.

The cam plate 62, guide plate 84, and outer boom section 52 may be coupled together using any suitable mechanical and/or non-mechanical fasteners, non-limiting examples of which include bolts (shown), pins, clamps, adhesives, welds, and combinations thereof. While the mounting plate 82 and guide plate 84 are illustrated as separate components, in an alternative configuration, the mounting plate 82 and guide plate 84 may be integrally formed. In still another configuration, the motor 54 may be mounted directly to the inner boom section 50.

Operation

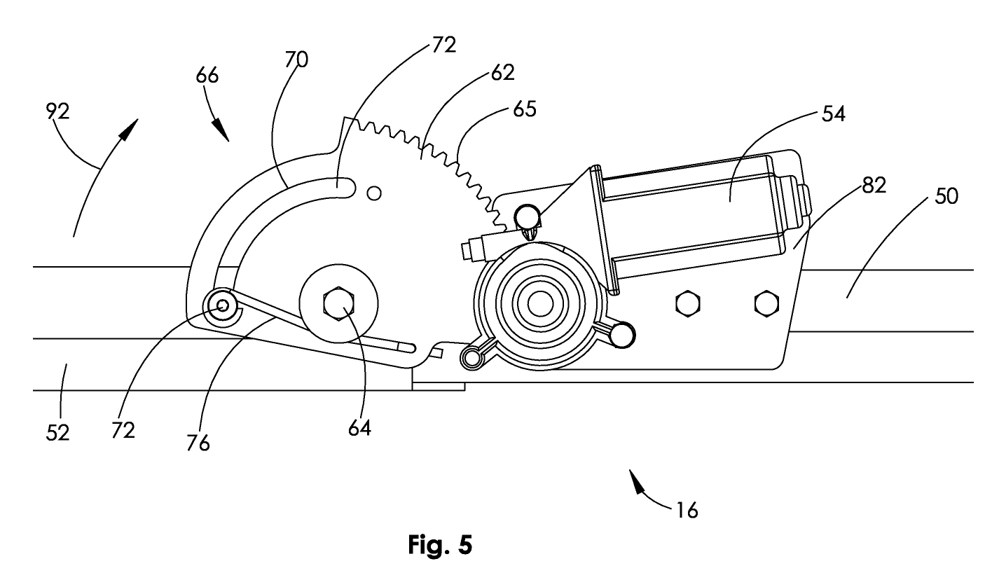

Referring now to FIGS. 2 and 5, the motor 54 may be used to selectively move the outer boom section 52 relative to the inner boom section 50 between the storage mode, illustrated in FIG. 2, and the sprayer mode, illustrated in FIG. 5. In the storage mode of FIG. 2, the outer boom section 52 is in a retracted position with respect to the inner boom section 50. In the retracted position, the outer boom section 52 extends generally parallel to the first and second sides 30, 32 of the chassis 20 and is oriented at an angle of about 90 degrees relative to the inner boom section 50. The retracted position is suitable for storage and/or transport of the spraying apparatus 10 and decreases the overall footprint of the spraying apparatus 10 compared to when the outer boom section 52 is extended in the sprayer mode. While the outer boom section 52 is illustrated as extending generally orthogonal to the inner boom section 50 in storage mode, it will be understood that the outer boom section 52 may extend at any angle less than or greater than 90 degrees, as desired.

When it is desired to apply a material to the landscaping surface using the sprayer apparatus 10, the motor 54 can be actuated by the user to pivot the outer boom section 52 relative to the inner boom section 50. The outer boom section 52 pivots about the pivot pin 64 from the storage mode of FIG. 2 to the sprayer mode of FIG. 5, as illustrated by arrow 90. In the sprayer mode, the outer boom section 52 is in an extended position suitable for applying a material through the spray nozzles 42. Extending the outer boom section 52 during sprayer mode can increase the area over which the material is sprayed. The outer boom section 52 may be extended to a position generally 180 degrees relative to the inner boom section 50 in the sprayer mode, as illustrated. However, in other embodiments, the outer boom section 52 may be configured to extend to any desired position relative to the inner boom section 50 for applying a material through the spray nozzles 42.

To move the outer boom section 52 into the sprayer mode of FIG. 5, the motor 54 can be actuated to rotate a gear (not shown) in a first direction. The gear is configured to engage the teeth 65 on the cam plate 62 to rotate the cam plate 62 in a first direction. Rotation of the cam plate 62 causes the outer boom section 52 to rotate about the pivot pin 64 as a result of the connection between the cam plate 62 and the outer boom section 52 through the biased follower pin 72. The outer boom section 52 can be returned to the storage mode of FIG. 2 by actuating the motor to rotate the cam plate 62 in a second direction, opposite the first direction, as illustrated by arrow 92, to rotate the outer boom section 52 about the pivot pin 64 back into the retracted position. As described above with respect to FIG. 2, the direction of rotation of the motor 54 can be reversed using the reverse polarity switch 58.

Still referring to FIG. 5, in the extended position, the breakaway assembly 66 biases the outer boom section 52 into a resting position with respect to the cam plate 62. The biasing element 76 is configured to bias the follower pin 72 that connects the outer boom section 52 to the cam plate 62 to a first end of the channel 70. When the outer boom section 52 is in the extended position and encounters an obstacle during movement of the spraying apparatus 10 over the ground surface, the outer boom section 52 is configured for breakaway movement against the bias of the follower pin 72. The channel 70 limits the breakaway movement of the outer boom section 52 by limiting the arc of travel through which the follower pin 72 travels relative to the cam plate 62. The channel 70 may limit the arc of travel during breakaway movement to any position between the fully extended position of the outer boom section 52 and the fully retracted position.

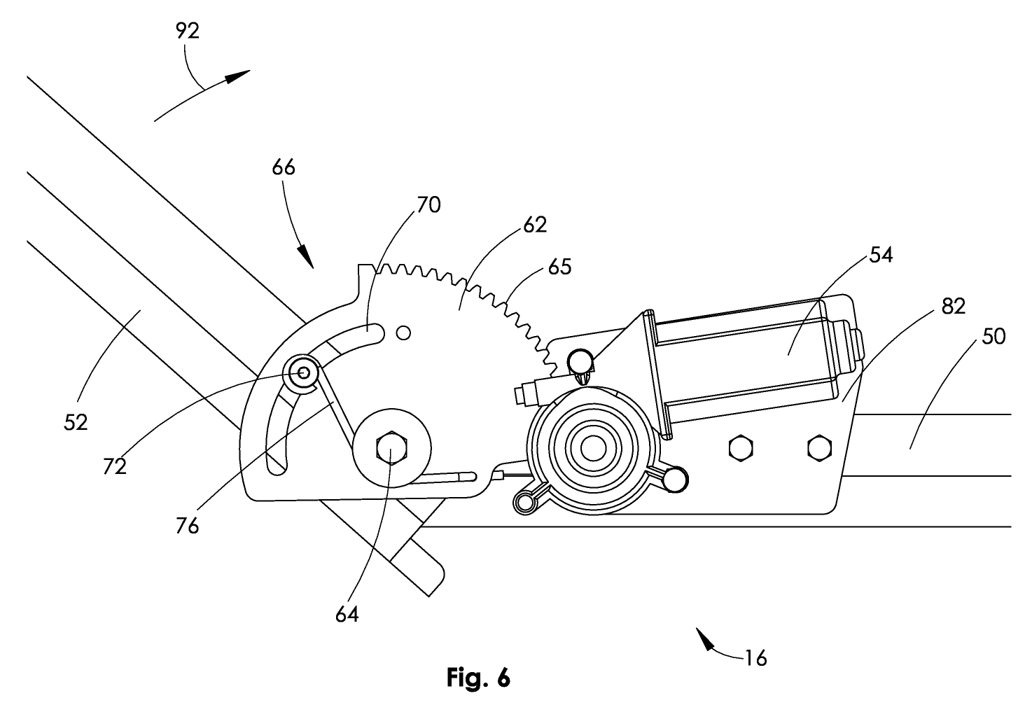

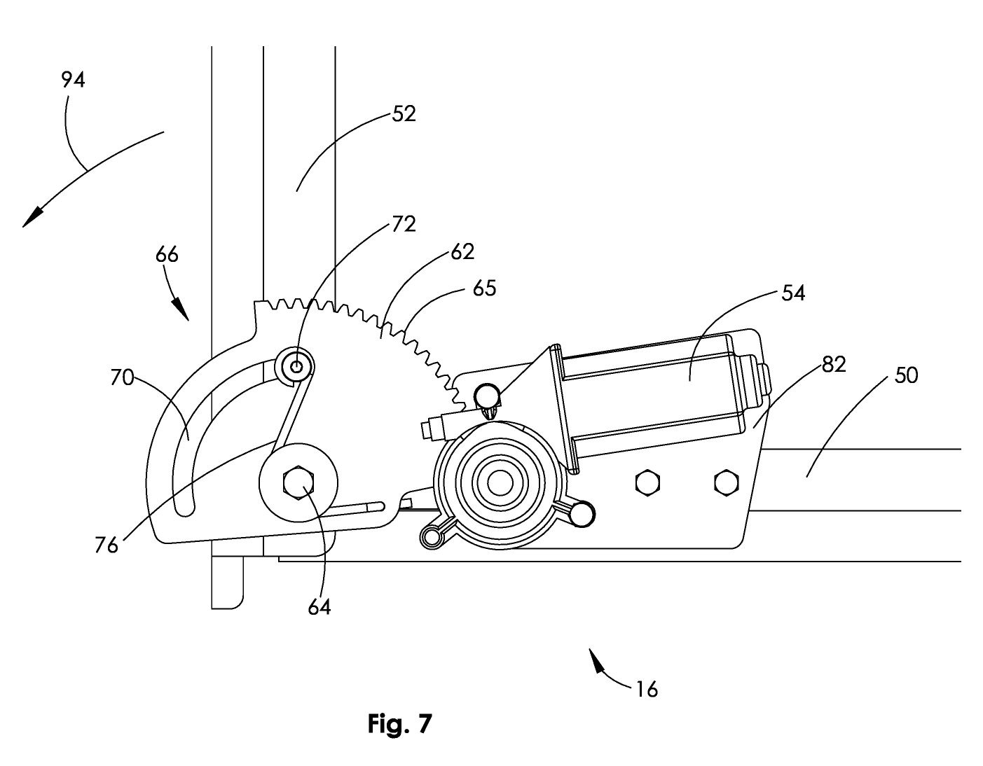

FIGS. 6 and 7 illustrate exemplary breakaway positions of the outer boom section 52 in response to encountering an obstacle. Depending on the dimensions of the obstacle and/or the force at which the outer boom section 52 engages the obstacle, the outer boom section 52 may travel from the resting position illustrated in FIG. 5 to an infinite number of the breakaway positions along the arc of travel defined by the channel 70 between the resting position of FIG. 5 and the breakaway position of FIG. 7. When the outer boom section 52 is no longer engaging the obstruction, the biasing element 76 applies a biasing force to the follower pin 72 to move the follower pin 72, and thus the outer boom section 52, back to the resting position illustrated in FIG. 5. In this manner, during use of the spraying apparatus 10 when the outer boom section 52 is the sprayer mode of FIG. 5, the outer boom section 52 can breakaway when an obstacle is encountered so as to minimize or avoid damage to the outer boom section 52 and/or the spray nozzle 42. The outer boom section 52 can then return back to its previous position once the obstacle is cleared, as illustrated by arrow 94 in FIG. 7. In this manner, the breakaway assembly 66 can save a user time during use of the spraying apparatus 10 by minimizing the number of stops the user has to make to remove debris or to travel around obstacles.

With reference to FIGS. 5, 6, and 7, during breakaway movement of the outer boom section 52, the cam plate 62 does not move relative to the inner boom section 50, thus maintaining the outer boom section 52 in sprayer mode. During breakaway movement, only the outer boom section 52 moves relative to the cam plate 62 and the inner boom section 50. This can save time during use of the spraying apparatus 10 by reducing the likelihood that a user would need to activate the motors 54 to retract the outer boom section 52 to avoid an obstacle in the path of the spraying apparatus. Further, this may allow the motor 54 to be operated to selectively position the outer boom section 52 in sprayer mode at any position along the teeth 65, while also allowing breakaway movement and return to the selected sprayer mode position.

While the outer boom section 52 is described in the context of movement between a retracted position and an extended position within a horizontal plane defined by the longitudinal axis of the inner boom section 50, in alternative embodiments, the outer boom section 52 may be configured for movement within a vertical plane orthogonal to the longitudinal axis of the inner boom section 50. For example, the outer boom section 52 may be coupled to the inner boom section 50 by a pivot pin 64 extending through the sides of the inner boom section 50, rather than the top and bottom, as illustrated in FIGS. 3 and 4. The motor 54, cam plate 62, and breakaway assembly 66 may similarly be positioned on the side of the inner boom section 50 to allow the outer boom section 52 to move within a vertical plane.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

1. A sprayer boom assembly for a mobile landscape spraying apparatus including a chassis and at least one wheel mounted to the chassis for movement of the spraying apparatus relative to a ground surface, the sprayer boom assembly comprising:
an inner boom section mounted to the chassis;
an outer boom section pivotably coupled to the inner boom section and moveable between an extended position and a retracted position;
a motor operably coupled to the outer boom section and configured to move the outer boom section relative to the inner boom section between the extended and retracted positions; and
a breakaway assembly coupled to the outer boom section, the breakaway assembly defining an arc of travel defined by a resting position and a breakaway position,
wherein when the outer boom section is placed in the extended position by the motor and the outer boom section encounters an obstruction, the outer boom section moves along the arc of travel from the resting position to the breakaway position in response to the obstruction.

2. The sprayer boom assembly of claim 1 wherein the breakaway assembly includes a biasing element adapted to bias the outer boom section into the resting position.

3. The sprayer boom assembly of claim 2 wherein as the outer boom section moves along the arc of travel toward the breakaway position in response to encountering an obstruction, the biasing element applies a biasing force to the outer boom section to drive the outer boom section back into the resting position.

4. The sprayer boom assembly of claim 1 wherein the motor is operably coupled to the outer boom section by a cam plate,
wherein the motor is adapted to rotate the cam plate to move the outer boom section between the extended and retracted positions.

5. The sprayer boom assembly of claim 4 wherein the breakaway assembly includes a channel formed in the cam plate defining the arc of travel.

6. The sprayer boom assembly of claim 5 wherein the outer boom section is connected to the cam plate by a follower pin inserted through the channel,
wherein the follower pin is moveable along the channel to allow the outer boom section to move between the resting and breakaway positions in response to encountering an obstruction.

7. The sprayer boom assembly of claim 6 comprising a biasing element connected to the follower pin to bias the outer boom section into the resting position.

8. The sprayer boom assembly of claim 1 wherein the outer boom section is coupled to the inner boom section by at least one of a pivot pin or a hinge.

9. The sprayer boom assembly of claim 1 wherein the outer boom section moves in a plane one of parallel to or orthogonal to a longitudinal axis of the inner boom section during movement between the extended and retracted positions.

10. A mobile landscape spraying apparatus comprising:
a drive assembly comprising:
a chassis having a front, a rear, and first and second opposing sides extending between the front and rear;
at least one wheel mounted to the chassis and adapted to move the spraying apparatus relative to a ground surface;
a dispensing assembly comprising:
a tank mounted to the chassis for holding a material to be sprayed;
a spray nozzle fluidly connected with the tank by a conduit for spraying material stored in the tank onto a landscaping surface;
a pump configured to selectively supply the material from the tank to the spray nozzle through the conduit; and
a sprayer boom assembly comprising:
a sprayer boom comprising an inner boom section mounted to the chassis and an outer boom section pivotably coupled to the inner boom section, the sprayer boom supporting the spray nozzle;
a motor mounted to the inner boom section and operably coupled with the outer boom section, the motor adapted to move the outer boom section relative to the inner boom section between (a) a sprayer mode in which the outer boom section is in an extended position for spraying the material stored in the tank onto the landscaping surface, and (b) a stored mode in which the outer boom section is in a retracted position;
a breakaway assembly coupling the outer boom section to the inner boom section, the breakaway assembly defining an arc of travel of the outer boom section relative to the inner boom section defined by a resting position and a breakaway position,
wherein when the outer boom section is in sprayer mode, the outer boom section is moveable between the resting position and the breakaway position in response to encountering an obstruction.

11. The spraying apparatus of claim 10 wherein the motor is coupled to the outer boom section by a cam plate,
wherein the motor is configured to rotate the cam plate to move the outer boom section between the sprayer mode and the stored mode.

12. The spraying apparatus of claim 11 wherein the breakaway assembly includes a follower pin moveably coupling the outer boom section to the cam plate.

13. The spraying apparatus of claim 12 wherein the cam plate includes a channel defining the arc of travel, the follower pin received in and moveable along the channel,
wherein the outer boom section is moveable along the arc of travel upon encountering an obstruction in the sprayer mode via movement of the follower pin within the channel.

14. The spraying apparatus of claim 12 wherein the breakaway assembly includes a biasing element biasing the outer boom section into the resting position,
wherein the biasing element imparts a biasing force to return the outer boom section to the resting position when the outer boom moves toward the breakaway position in response to encountering an obstruction.

15. The spraying apparatus of claim 10 comprising a first sprayer assembly on the first side of the chassis and a second sprayer assembly on the second side of the chassis,
wherein the first sprayer assembly sprays material onto the landscaping surface adjacent the first side in sprayer mode and the second sprayer assembly sprays material on the landscaping surface adjacent the second side in sprayer mode.

16. The spraying apparatus of claim 10 wherein the sprayer assembly further comprises a user selectable actuator operably coupled to the motor to selectively control the motor to move the outer boom section between the sprayer mode and the stored mode.

17. The spraying apparatus of claim 10 wherein the outer boom section moves in a plane one of parallel to or orthogonal to a longitudinal axis of the inner boom section during movement between the extended and retracted positions.

18. A method of use for a sprayer boom assembly of a mobile landscape spraying apparatus, the mobile spraying apparatus including a chassis and at least one wheel mounted to the chassis for movement of the spraying apparatus relative to a ground surface, the method comprising:
providing an inner boom section mounted to the chassis;
providing an outer boom section pivotably coupled to the inner boom section and moveable between an extended position and a retracted position;
driving the outer boom section relative to the inner boom section from the retracted position to the extended position; and
in response to the outer boom section encountering an obstruction, pivoting the outer boom section from the extended position to a breakaway position to facilitate clearing the obstruction.

19. The method of claim 18 comprising biasing the outer boom section to return to the extended position after the obstruction is cleared.

20. The method of claim 18 wherein driving the outer boom section comprises actuating a motor to drive the outer boom section from the retracted position to the extended position.
